(19) United States
(12) Patent Application Publication
(10) Pub. No.: US 2016/0029651 A1
(43) Pub. Date: Feb. 4, 2016

(54) METHOD FOR STORING SUBSTANCES IN ORGANIC SOLIDS

(71) Applicant: RUDOLF WILD GMBH & CO. KG, Eppelheim (DE)

(72) Inventors: Dominique CHATARD, Heidelberg (DE); Wolfgang TILZ, Schwetzingen (DE); Axel DE WITH, Plankstadt (DE); Thomas BORRMANN, St. Leon-Rot (DE)

(21) Appl. No.: 14/781,397

(22) PCT Filed: Mar. 27, 2014
(86) PCT No.: PCT/EP2014/000837

§ 371 Date: Sep. 30, 2015

(30) Foreign Application Priority Data
Apr. 3, 2013 (EP) 13001704.9

(51) Int. Cl. A23B 4/02; A23L 1/216; A23B 7/08

(52) U.S. Cl. CPC A23B 4/02; A23B 7/085; A23L 1/216; A23V 2002/00

(57) ABSTRACT

The invention relates to a method for storing a substance in an organic solid matter, comprising the treatment of the organic solid matter by means of a solution of the substance to be stored, and reducing the pressure, characterized in that the weight ratio of the organic solid matter to the resolution is 0.5:1, or greater. A solid food (fruit, roots, vegetables, meat, or fish), wood or bark (commercial timber, tooth picks) are used for an organic solids.

The present invention relates to a method for storing substances in organic solids such as foods or wood.

Substances are stored in foods in order to increase the content of one or more particular substances in the food, e.g., for preserving and conserving. Further methods of preservation are, e.g., canning, freezing, drying, placement into alcohol or conserving solutions, or fermenting.

A known method to preserve fruits and produce, which is based on the storage of sugar, is candying. In candying, the sugar content of fruits or produce is increased. Candying is furthermore used in order to achieve an improvement in the taste of the fruits or produce.

The candying of fruits is a process in which the cell water of the fruit is largely replaced with syrups of sugars. In this process fruits or pieces of fruit are placed into a sugar solution. Candying is based on an osmotic process in which the water contained in the fruit, the colour, the organic acids, minerals and flavours escape to some extent and thereby pass into the surrounding solution. The released volume allows the sugar solution to enter the fruit.

The osmotic process takes place due to the concentration difference found in the water contained in the fruit, which is normally approximately 85-90 wt. %, and that in the sugar syrup surrounding the fruit. Potential differences arise due to the concentration differences in the fruit and the surrounding solution. During osmosis, a balancing of the potential differences occurs; the osmotic movement continues until the chemical potential of the diffusing components on both sides of the membrane (i.e., between the fruit and the solution) has levelled out and an osmotic balance has resulted. Because the concentration of all dissolved substances balances out due to the potential difference, the concentration of sugar in the fruit rises while a concentration drop simultaneously occurs in the solution. In osmosis, two differently directed mass flows occur: Water flows out of the fruit into the surrounding solution and dissolved substances flow from the solution into the fruit. If a balance has come into being between the fruit and the solution, the addition of sugar to the solution or the withdrawal of water (such as by vaporizing the sugar solution without fruit in a separate process step, for example) can again produce a potential difference.

Osmosis designates diffusion through a semipermeable membrane, i.e., a membrane that is only selectively penetrable. A cell membrane's semi-permeability also depends on its function. As a rule, the balancing of the concentration between the cell interiors and exteriors can be achieved through the diffusion of substances. However the particular diffusion speeds through a semi-permeable membrane can be different. For example, in most living cells water can passively diffuse, while other substances such as glucose can only penetrate into the cell by means of so-called facilitated diffusion. In facilitated diffusion, the substance is transported with the help of transport proteins.

Furthermore, physical quantities (e.g., temperature, pressure, electric fields), possibly caused by local mechanical effects such as distortion due to the water's phase transition during vaporization or due to electromagnetic waves, can influence the diffusion process.

The percentage of soluble solid content in the inside of fruits is up to 80 wt. % in candied fruits. The shelf life of candied fruits is guaranteed for many months even without cooling. However the candying times are relatively long and can be up to 12 days, depending on the type and size of the fruit. The natural colouring of the fruit is also lost during the candying. Colouring substances, such as natural colouring substances that are not required to be identified, or colouring substances that are required to be identified, such as E120, E104, E127, are therefore commonly added to compensate. Flavours are also lost during the candying. For this reason, as a rule flavours are to be added to the solution so that the fruit has an aromatic flavour after the candying. For this reason, nature-identical flavours and citric acid (E330) are used, among other agents. In addition, antioxidants and sulphur dioxide (E220) are used for stabilisation.

A further method for preserving foods is curing, which is based on the storage of salt. Curing is normally used to preserve meat. In this case, water is withdrawn from the meat by means of osmosis and the salt content is increased. Salt (NaCl) or pickling salt furthermore also has a preserving effect.

A further method for preserving food is vacuum drying. In this method, a vacuum is applied in order to withdraw water from the food. However the vacuum also causes many flavouring substances to be removed.

US 666,413 describes a device and a method for candying fruits with heated sugar solutions. Water and sugar syrup are pumped into a pressure vessel that contains the fruit by means of the application of a vacuum. The addition of water or syrup is repeated until the sugar solution in the pressure vessel has the required concentration. Once the required concentration has been reached, water is added in proportion to the vaporization rate until the candying is completed.

Zhao and Xie, Trends in Food Science & Technology 2004, 434-451 describe the technique of vacuum impregnation. Vacuum impregnation allows desired substances to be stored into foods. In this process, a product is placed into a solution and a vacuum is applied for a short time. The vacuum is then removed and the pressure is again increased to the atmospheric pressure. In the first step under vacuum gases that are contained in the product are removed/displaced due to their disproportionate increase in volume. The increase to atmospheric pressure allows the surrounding liquid to flow into the resulting volumes in place of the gas that was withdrawn.

Different osmotic methods are also described in the article: osmotic dehydration, osmotic dehydration in a vacuum and osmotic dehydration with pulsed vacuum. In osmotic dehydration, aqueous food is placed into a highly concentrated sugar or salt solution. The osmotic dehydration removes a substantial portion of the water, while only minor quantities of solids are stored. With osmotic dehydration in a vacuum, the substance exchange is significantly higher and consequently a clear reduction in the treatment time is achieved. Here again only a small quantity of solids is stored. With osmotic dehydration with pulsed vacuum, the food is placed into the osmotic solutions and a vacuum is applied for a short time (5 to 15 minutes). The vacuum is subsequently removed and the pressure is increased to atmospheric pressure again.

Paes et al., Brazilian Archives of Biology and Technology 2008, 51(4), 799-806 describe vacuum impregnation of apples at different temperatures. Here apples are placed into a sugar solution with 50° Brix for 25 min at 40 mbar. This is followed by relaxation for 15 min. The weight ratio of fruit to sugar solution here is 1:50 in order to prevent changes in the sugar concentration of the solution. This method requires a large quantity of sugar solution which, due to the enrichment with dissolved substances from the treated foods, can be reused only to a very limited degree and which must subsequently be disposed of. This is detrimental with regard to economic efficiency and sustainability.

Ursachi et al., Journal of Agroalimentary Processes and Technologies 2009, 15(2), 316-319 likewise describe the vacuum impregnation of fruits. In this case apples are treated with an impregnation solution in a vacuum. The ratio of fruit to impregnation solution here amounts to 1:10. Here again large quantities of impregnation solution are needed.

Beret et al., Journal of Food Science 2002, 67(8), 3046-3052 describe vacuum impregnation of pineapple, whereby the fruits are treated with an impregnation solution for 15 min at 50 mbar and 15 min at atmospheric pressure. The ratio of fruit to impregnation solution here amounts to 1:20. This method likewise requires large quantities of impregnation solution.

DE-A-199 24 624 describes a device and a method for drying products. Here the product to be dried is heated with a microwave emitter and at least one heating element. The microwave emitter heats the interior of the product while the heating element heats the surface of the product to be dried. To support the drying process, the product can be treated in a pressure vessel in which negative pressure prevails. As a result of the negative pressure, the escape of the moisture vapour from the product to be dried is simplified. However flavouring substances of the product to be dried can be removed with the water vapour content during the drying.

The recovery of flavouring substances during beer brewing is described in DE-A-10 2007 045 685. In this case, the exhaust vapour which contains flavour and which escapes during the boiling phase of the wort is directed into a rectification column in which the vapours are rectified, whereby distillates containing flavour are obtained that can either be fed back into the wort after the boiling phase or stored in a container.

EP-A-0 292 048 describes a method for producing a juice and for the recovery of the flavouring substances that are released during the manufacture. The volatile flavouring substances are directed to the upper side of a stripping column by a mist eliminator and condensed at temperatures from 105° F. (40.6° C.) to −320° F. (−196° C.) in two or more coolers at different temperatures and arranged one behind the other. In the first cooler stage at a temperature of 60° F. (15.6° C.) to 105° F. (40.6° C.) primarily water and some of the flavouring substances are condensed. In the second stage at temperatures between 33° F. (0.5 ° C.) to 60° F. (15.6° C)water and the less highly volatile substances are likewise condensed. In the third stage at a temperature from −50° F. (−45.5° C.) to −320° F. (196° C.) the volatile flavouring substances are condensed.

The object of the present invention is to provide a method that is efficient and economical for storing a substance in an organic solid. If the organic solid is a solid food, it is also the object to provide a food with a natural flavour and appearance (colour and structure) and where applicable to preserve it. If the organic solid is, for example, wood, it is also the object to conserve, colour or aromatize it. This object is solved by a method for storing a substance in an organic solid, comprising the treatment of the organic solid with a solution of the substance to be stored and reduction of the pressure, characterised in that the weight ratio of organic solid to solution is 0.5:1 or greater.

Surprisingly, the inventive method allows the storage of a substance in an organic solid whereby the ratio of the solution of the substance to be stored compared to methods described in the state of the art is significantly reduced.

This object is also solved by an organic solid that was manufactured in accordance with the inventive method.

Preferred embodiments are described in the dependent claims 2 to 12 and 14.

According to the invention, “organic solids” are, for example, a solid food or wood and bark that come into contact with food (e.g., toothpicks, wood chips for aromatization), but also commercial timber in general whose durability can be improved by means of impregnation. According to the invention the term “solid food” is understood to be a food that has a cell structure and that has a defined shape. Examples of solid foods are fruits, vegetables, meat, fish, mushrooms and pieces of the same.

Suitable fruits are, e.g., apples, pineapples, pears, cherries, raspberries, strawberries, tomatoes or peppers.

Suitable vegetables are, e.g., roots and tubers, such as radishes, carrots, celery root, ginger, topinambur or potatoes, or bulbous plants such as shallots, onion and garlic.

Suitable meat is, e.g., beef or lamb or reindeer meat.

Suitable fish are, e.g., trout or herring.

According to the invention, the term “storage” is understood to mean the insertion of a substance, here in an organic solid. The substance thereby penetrates into the cells of the organic solid. The term “impregnation” is synonymous and is alternatively used.

According to the invention, the term “solution of the substance to be stored” is understood to be a solution that contains the substance to be stored (alternative name: impregnation solution). Consequently, e.g., a sugar solution contains sugar as the substance to be stored.

In a preferred embodiment in conjunction with one of the embodiments named above or below, the organic solid is a solid food. The solid food is preferably selected from fruits, vegetables, fish or meat. More preferably, the solid food is selected from soft fruit, stone fruit, melons, pumpkins, tubers, roots, red meat and saltwater fish. In particular, the solid food is selected from apples, pineapples, raspberries, strawberries, ginger, potatoes or beef. In a further preferred embodiment in conjunction with one of the embodiments named above or below, the weight ratio of organic solid to solution is from 1:1 to 20:1, more preferably 5:1 to 15:1, particularly 10:1.

In a preferred embodiment in conjunction with one of the embodiments named above or below, the solution of the substance to be stored is an aqueous solution. More preferably, the aqueous solution of the substance to be stored is a sugar solution, a sugar syrup, a salt solution, a solution with a positive nutritional-physiological or healthy effect, an aromatized or coloured solution, a solution with calcium salts and pectin methylesterase to stabilize the solid food, a solution to conserve as protection against microbiological spoilage or breakdown or a mixture of these. In particular, the solution of the substance to be stored is a sugar syrup.

According to the invention, the term “a solution with a positive nutritional-physiological or health effect” is understood to mean a solution that has one or more substances with positive nutritional-physiological or health effects. Components with a positive nutritional-physiological or health effect are, e.g., vitamins, minerals, dietary fibres, secondary phytonutrients, such as, e.g., polyphenols, phytosterols, carotenoids, blood sugar-regulating sugar alcohols, starter cultures with probiotic effect such as lactic acid and bifido bacteria e.g., Lactobacillus acidophilus, Lactobacillus sakei, Lactobacillus rhamnosus, Bifidobacterium longum, or mixtures of these.

According to the invention, the term “aromatized solution” is understood to mean a solution that contains one or more flavouring substances. Common flavouring substances are, e.g., for peaches gamma decalactone in a concentration of 5 ppm and for strawberries furaneol and maltol, each in a concentration of 5 and 10 ppm or mixtures of these.

According to the invention, the term “coloured solution” is understood to mean a solution that contains one or more colouring substances. Common natural colouring substances are extracts containing anthocyan, e.g., from black carrots or from soft red fruits, extracts containing betanin, e.g., from red beets, extracts containing chlorophyll, e.g., from stinging nettles, spinach, extracts containing carotenoid, e.g., from carrots, tomatoes, or mixtures of these.

The term “solution to conserve as protection against microbiological spoilage or breakdown” is understood to mean solutions that contain salts permitted in foods, such as table salt (NaCl), nitrite or nitrate, sorbates, sulphur compounds or benzoates, but also microbicides that protect wood and bark from microbiological decay (rot).

In a further preferred embodiment in conjunction with one of the embodiments named above or below, the inventive method comprises the condensation of the formed exhaust air. The condensation of the exhaust air can take place in the manner known to persons skilled in the art, e.g., with cold traps or coolers.

According to the invention, the term “exhaust air” is understood to mean the air flowing freely out of an area or forced out of an area.

In a further preferred embodiment in conjunction with one of the embodiments named above or below, a fractioning of the exhaust air can take place, e.g., by means of cooling the individual cool traps to different temperatures.

As a result of the condensation of the exhaust air, released flavouring substances can be recovered. In a preferred embodiment in conjunction with one of the embodiments named above or below, the flavouring substances obtained from the exhaust air are added back to the food.

In a preferred embodiment in conjunction with one of the embodiments named above or below, the pressure amounts to 0.05 to 250 mbar. More preferably the pressure is 5 to 50 mbar, particularly 15 to 20 mbar.

In a further preferred embodiment in conjunction with one of the embodiments named above or below, the solution is heated.

In another preferred embodiment in conjunction with one of the embodiments named above or below the temperature of the solution amounts to 0 to 65° C., more preferably 20 to 50° C., particularly 30 to 40° C. The heating preferably takes place by means of electromagnetic waves, e.g., microwaves, radio waves or infrared radiation. However the heating can also take place in pulses by means of switching the heating energy on and off. The heating can take place at the bottom of the container so that the rising vapour bubbles produce circulation that brings about turbulence of the food to be treated and in this way avoids overheating the food.

If the inventive method is carried out at these temperatures, the storage process is facilitated and loss of natural flavouring substances and colouring substances is reduced.

If the inventive method is carried out at these temperatures, the storage of the desired substance is furthermore carried out in an especially gentle manner.

In a further preferred embodiment in conjunction with one of the embodiments named above or below, the inventive method takes place under the exclusion of oxygen. If the inventive method is carried out under the exclusion of oxygen, there is no loss of quality due to oxidation.

In a further preferred embodiment in conjunction with one of the embodiments named above or below the concentration of the solution amounts to 300 to 850 g/l, more preferably 400 to 800 g/l, particularly 500 to 750 g/l. The sugar concentration of the solution preferably amounts to 300 to 850 g/l, more preferably 400 to 800 g/l, particularly 500 to 750 g/l.

In a further preferred embodiment in conjunction with one of the embodiments named above or below, the solution has a Brix of 50 to 80° Bx.

The term “Bx” (degree Brix) is a unit of measure for the relative density of liquids. A liquid has one degree Brix (1° Bx) if it has the same density as a solution of 1 g sucrose in 100 g sucrose/water solution; it has 10 Brix (10° Bx) if its density is the same as a solution of 10 g sucrose in 100 g sucrose/water solution (corresponds to a ten percent solution).

In a preferred embodiment in conjunction with one of the embodiments named above or below, the solution additionally contains at least one colouring substance, flavour enhancer, antioxidant, acidifying agent, such as citric acid or trisodium citrate, flavouring substance, preservative or substance with positive nutritional-physiological or health effect as well as a combination of these. More preferably the solution contains a blood sugar-regulating substance, in particular a sugar alcohol.

In order to carry out the inventive method, normally a device is used which comprises a vessel in which a negative pressure can be generated along with a pump to reduce the pressure in the vessel.

In a preferred embodiment in conjunction with one of the embodiments named above or below the device furthermore comprises a heating device to heat the solution.

In a further preferred embodiment in conjunction with one of the embodiments named above or below the device comprises at least one cold trap or condenser to collect the exhaust air.

Preferably only the vessel and the cold trap are connected to a vacuum pump. The vapours escaping from the vessel are condensed in the cold trap. The volatile flavouring substances can be recovered from the condensate. Alternatively, the entire process area including the heating device can also be under vacuum.

In a further preferred embodiment in conjunction with one of the embodiments of the device named above or below, the exhaust air is monitored by means of a sensor installed in the connection line between the vessel and the cold trap so that the power output can be adapted to the signal of the sensor (e.g., water vapour level). The pump that generates the vacuum can be correspondingly regulated in order to minimize the pump's energy consumption.

The condensation can be monitored in steps where appropriate by means of further sensors in the connection line between the first cold trap and the downstream cold traps.

The present invention is explained in more detail by the following examples.

### EXAMPLES

### Example 1

### Candying Strawberries with Sugar

1 kg deep-frozen strawberries are placed into a vessel with 0.2 kg of a 72 wt.-% sugar solution. The pressure in the vessel is set to 20 mbar. The strawberries are heated to a temperature of a maximum of 50° C. by connecting an infrared lamp located in the reaction vessel or by an infrared lamp that lights from outside through a transparent reaction vessel, wherein the adjusted vacuum of 20 mbar is maintained by means of a vacuum pump connected to the reaction vessel. In a cold trap upstream of the pump the exhaust vapour contained in the exhaust air is condensed. After collecting 900 ml of condensate, the pressure in the reaction vessel is increased to normal pressure. As a result one obtains 0.3 kg candied strawberries. The candied strawberries have a natural taste and a shrunken natural appearance.

### Example 2

Impregnation of Potatoes with a Salty Solution with Onion Flavouring

1 kg cut potatoes are placed into a vessel with 0.8 kg of an aqueous solution of 0.04 kg salt and 0.00025 g onion flavouring (WILD Inc.). The potatoes are heated to a temperature of 70° C. by connecting an infrared lamp located in the reaction vessel or by an infrared lamp that lights from the outside though a transparent reaction vessel, and after soaking the native starch contained in the potatoes a vacuum of 50 mbar is brought about by means of a vacuum pump connected to the reaction vessel and is then subsequently maintained. In a cold trap upstream of the pump the exhaust vapour contained in the exhaust air is condensed. After 15 min the pressure in the reaction vessel is increased to normal pressure and the salty solution is removed. Then the process is continued at 20 mbar for 60 minutes. After 700 ml of condensate has been collected, the pressure in the reaction vessel is increased to normal pressure. As a result one obtains 0.25 kg partially dried, cooked potatoes with an onion taste.

### Example 3

### Curing Beef with Salt Water

1 kg beef is placed into a vessel with 0.8 kg of a 5 wt. % salt solution, so that the meat is covered. The pressure in the vessel is brought to 20 mbar. The beef is heated to a temperature of 30° C. by connecting an infrared lamp located in the reaction vessel or by an infrared lamp that lights from the outside though a transparent reaction vessel, wherein the adjusted vacuum of 20 mbar is maintained by means of a vacuum pump connected to the reaction vessel. In a cold trap upstream of the pump the exhaust vapour contained in the exhaust air is condensed. After 15 min the pressure in the reaction vessel is increased to normal pressure and the salt solution is removed. Then the process is continued at 20 mbar for 60 minutes. After 250 ml of condensate is collected, the pressure in the reaction vessel is increased to normal pressure. As a result one obtains 0.5 kg cured and partially dried beef.

### Example 4

### Impregnation of Toothpicks with Vanilla Flavour

200 g commercially available toothpicks are placed into a vessel with 100 ml of an aqueous solution aromatized with 0.005 g nature-identical vanilla flavouring. The pressure in the vessel is brought to 100 mbar with a vacuum pump. The toothpicks and the solution are kept at a temperature of 55° C. by connecting a microwave located in the reaction vessel or by a microwave that radiates from the outside though a transparent reaction vessel. In a cold trap upstream of the pump the exhaust vapour contained in the exhaust air is condensed and fed back to the toothpicks where applicable. The process is carried out for 100 minutes. The pressure in the reaction vessel is then increased to normal pressure. As a result one obtains toothpicks that pleasantly taste of vanilla even after having been stuck in a fruit for hours.

1. Method for storing a substance in an organic solid comprising
the treatment of the organic solid with a solution of the substance to be stored and
reduction of the pressure,
characterised in that the weight ratio of organic solid to solution is 0.5:1 or greater.

2. Method according to claim 1, wherein a solid food or wood or bark is used as the organic solid.

3. Method according to claim 2 wherein fruits, roots, vegetables, meat or fish is used as the food.

4. Method according to one of the claims 1 to 3 wherein the weight ratio of organic solid to solution is 1:2 to 20:1.

5. Method according to one of the claims 1 to 4 wherein an aqueous solution is used as the solution.

6. Method according to claim 5 wherein a sugar solution, a sugar syrup, a salt solution, a solution with a positive nutritional-physiological or health effect, a solution with calcium salts and pectin methylesterase, an aromatized or coloured solution, a preservative or a mixture of these is used.

7. Method according to one of the claims 1 to 6, furthermore comprising
the condensation of the formed exhaust air.

8. Method according to one of the claims 1 to 7 wherein the organic solid is heated together with the existing solution.

9. Method according to one of the claims 1 to 8 wherein the temperature of the solution amounts to 0° C. to 65° C.

10. Method according to one of the claims 1 to 9 wherein the pressure amounts to 0.05 to 250 mbar.

11. Method according to one of the claims 1 to 10 wherein the solution has a Brix of 30 to 85° Bx.

12. Method according to one of the claims 1 to 11 wherein the solution additionally contains at least one colouring substance, flavour enhancer, antioxidant, acidifying agent, preservative or substance with a positive nutritional-physiological or health effect.

13. Organic solid, manufacturable according to a method according to one of the claims 1 to 12.

14. Organic solid according to claim 13 wherein the organic solid is a food.
